(19) United States
(12) Patent Application Publication
(10) Pub. No.: US 2021/0097290 A1
(43) Pub. Date: Apr. 1, 2021

(54) VIDEO RETRIEVAL IN FEATURE DESCRIPTOR DOMAIN IN AN ARTIFICIAL INTELLIGENCE SEMICONDUCTOR SOLUTION

(71) Applicant: Gyrfalcon Technology Inc., Milpitas, CA (US)

(72) Inventors: Lin Yang, Milpitas, CA (US); Bin Yang, San Jose, CA (US); Qi Dong, San Jose, CA (US); Xiaochun Li, San Ramon, CA (US); Wenhan Zhang, Mississauga (CA); Yequn Zhang, San Jose, CA (US); Hua Zhou, San Jose, CA (US); Patrick Dong, San Jose, CA (US)

(73) Assignee: Gyrfalcon Technology Inc., Milpitas, CA (US)

(21) Appl. No.: 16/586,543

(22) Filed: Sep. 27, 2019

(51) Int. Cl. G06K 9/00; G06F 16/738; G06F 16/74; G06N 3/04; G06N 3/063

(52) U.S. Cl. CPC G06K 9/00744; G06K 9/00758; G06N 3/063; G06F 16/743; G06N 3/04; G06F 16/738

(57) ABSTRACT

A video retrieval system may include a feature extractor configured to extract first feature descriptors for multiple image frames in the query video. The system may also include a feature extractor to extract second feature descriptors for multiple image frames in a candidate video in a video database. The system may include a comparator to compare the first and second feature descriptors to determine a subset of image frames in the candidate video that are similar to the first video. The system may output die query output by displaying the subset of image frames in a slide show. The system may also output the query by displaying a video formed by at least the subset of image frames. The feature extractor may be implemented in a convolution neural network (CNN) in an artificial intelligence (AI) chip. The system may include key frame extractor to detect key frames in the video.

### FIELD

This patent document relates generally to systems and methods for retrieving video. Examples of retrieving video in feature descriptor domain in an artificial intelligence semiconductor solution are provided.

### BACKGROUND

In video analysis and other applications, such as video retrieval, processing of image pixels is often performed. This requires high computing power because of large amount of information in image pixels. For example, a one-hour video captured in 30 frames per second may contain 108,000 image frames. If the video resolution is the standard VGA at 640×480, the number of pixels in the video w ill amount to 30 billion pixels. Some existing systems extract key frames from a video before performing further analysis, so that the computation is limited to processing key frames instead of all of the image frames in the video. Key frame detection generally determines the image frames in a video where an event has occurred. The examples of an event may include a motion, a scene change or other condition changes in the video. Key frame detection generally processes multiple image frames in the video and may still require extensive computing resources. Other technologies may include selecting a subset of image frames in a video either at a fixed time interval or a random time interval, without assessing die content of the images in the video. However, these methods may be less than ideal because the image frames selected may not be the true key frames that reflect when an event occurs. In other words, a randomly selected key frame may be redundant to a previous key frame, thus the randomly selected key frame does not provide any valuable information. Further, whether key frame based or non-key frame based, video retrieval may require comparing image frames (e.g., in a query video) to image frames (e.g., in a video database). This comparing process is based on processing image pixels and thus requires large computations.

This document is directed to systems and methods for addressing the above issues and/or other issues.

### BRIEF DESCRIPTION OF THE DRAWINGS

The present solution will be described with reference to the following figures, in which like numerals represent like items throughout the figures.

FIG. 1 illustrates a diagram of an example video retrieval system in accordance with various examples described herein,

FIGS. 2-3 illustrates diagrams of an example feature extractor that may be embedded in an AI chip in accordance with various examples described herein.

FIG. A illustrates a flow diagram of an example process of retrieving video from a video database in accordance with various examples described herein.

FIG. 5 illustrates a flow diagram of an example process of detecting key frames in a video segment in accordance with various examples described herein.

FIG. 6 illustrates various embodiments of one or more electronic devices for implementing the various methods and processes described herein.

### DETAILED DESCRIPTION

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

Examples of “artificial intelligence logic circuit” or “AI logic circuit” include a logic circuit that is configured to execute certain AI functions such as a neural network in AI or machine learning tasks. An AI logic circuit can be a processor. An AI logic circuit can also be a logic circuit that is controlled by an external processor and executes certain AI functions.

Examples of “integrated circuit,” “semiconductor chip.” “chip,” or “semiconductor device” include an integrated circuit (IC) that contains electronic circuits on semiconductor materials, such as silicon, for performing certain functions. For example, an integrated circuit can be a microprocessor, a memory, a programmable array logic (PAL) device, an application-specific integrated circuit (ASIC), or others. An integrated circuit that contains an AI logic circuit is referred to as an AI integrated circuit.

Examples of an “AI chip” include hardware- or software-based device that is capable of performing functions of an AI logic circuit. An AI chip can be physical or virtual. For example, a physical AI chip may include an embedded cellular neural network, which may contain weights and/or parameters of a convolution neural network (CNN) model. A virtual AI chip may be software-based. For example, a virtual AI chip may include one or more processor simulators to implement functions of a desired AI logic circuit of a physical AI chip.

Examples of “AI model” include data that include one or more weights that, when loaded inside an AI chip, are used for executing the AI chip. For example, an AI model for a given CNN may include the weights, biases, and other parameters for one or more convolutional layers of the CNN. Here, the weights and parameters of an AI model are interchangeable.

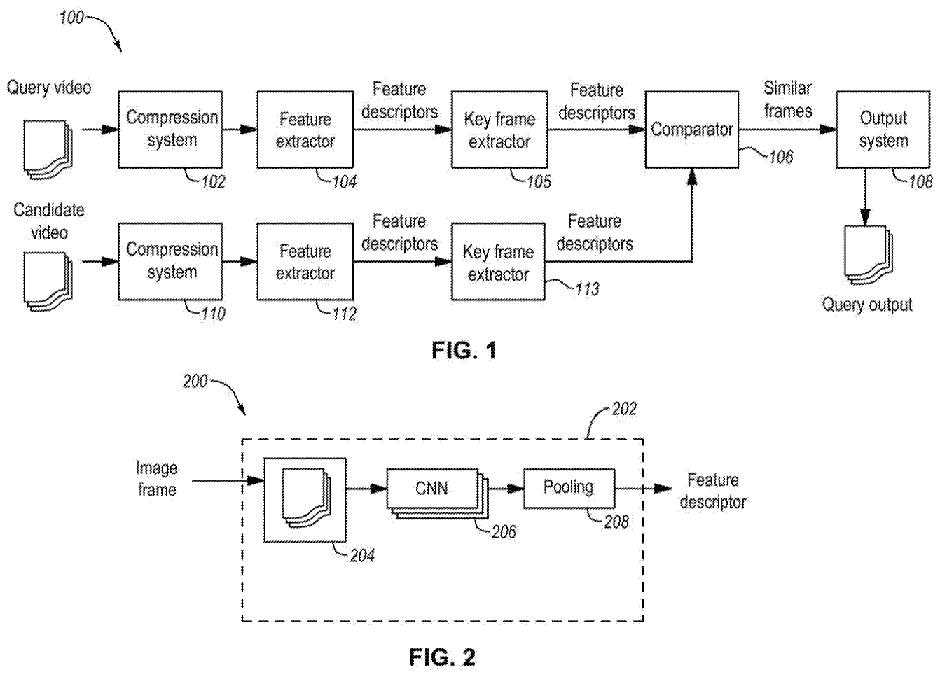

FIG. 1 illustrates an example video retrieval system in accordance with various examples described herein. A system 100 may include a feature extractor 104 configured to extract one or more feature descriptors from multiple images in a query video. Examples of a feature descriptor may include any values that are representative of one or more features of an image. For example, the feature descriptor may be obtained from a feature map of an image generated through a CNN. In such case, the feature descriptor may include a vector containing values representing multiple channels in the feature map. In a non-limiting example, an input image of the CNN may have 3 channels, whereas the feature map from the CNN may have 512 channels. Thus, die feature descriptor may be a vector having 512 values. The output feature descriptors from die feature extractor 104 may include multiple vectors from the multiple images in the query video.

In some examples, the system 100 may also include a feature extractor 112 configured to extract one or more feature descriptors from multiple images in a candidate video in a video database. Similar to the feature extractor 104, examples of a feature descriptor from the feature extractor 112 may also include any values that are representative of one or more features of an image. For example, the feature descriptor may include a vector containing values representing multiple channels of a feature map of any of the multiple images in the candidate video. In a non-limiting example, an input image of the CNN may have 3 channels, whereas the feature map from the CNN may have 512 channels. In such case, the feature descriptor may be a vector having 512 values. The output feature descriptors from the feature extractor 112 may include multiple vectors from the multiple images in a video in the video database. In a non-limiting example, a candidate video in the video database may be fed to the feature extractor 112 to generate the feature descriptors for the candidate video. In some examples, the feature extractors 104, 112 may be implemented in a CNN, which will be further described in the present disclosure.

With further reference to FIG. 1. the system 100 may further include a comparator 106 configured to assess and compare the feature descriptors from the feature extractor 104 and the feature descriptors from the feature extractor 112 to determine a subset of image frames in the candidate video. For example, the subset of image frames may include one or more image frames in the candidate video that are similar to the query video. The system 100 may further include an output system 108 configured to provide query output based on the similar image frames provided from the comparator 106. In some examples, the system 100 may display all similar image frames sequentially in a slide show. In other examples, the system 100 may display a video clip comprising the similar frames and additionally the image frames in between the similar image frames so that the video clip is a continuous video. Other forms of the query output may also be possible.

In some examples, the system 100 may access multiple image frames, e.g., a sequence of image frames, of the query video or the candidate video in the video database. For example, the system may access the query video or the candidate video stored in a memory or on the cloud over a communication network (e.g., the Internet), and extract the sequence of image frames in the video. In some or other scenarios, the system may receive a query video or a plurality of image frames directly from an image sensor. The image sensor may be configured to capture a video or an image. For example, the image sensor may be installed in a video surveillance system and configured to capture video/images of a vehicle exiting a garage, a parking lot, or a building. The system 100 may be configured to search the previous stored surveillance video in a video database to retrieve a similar video of the same vehicle to verify that the video exiting the garage had previously entered the same garage.

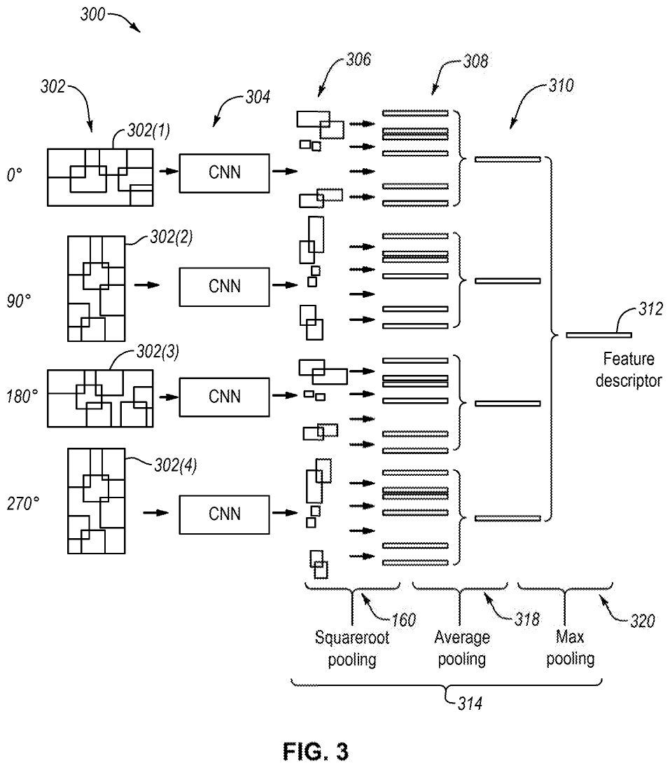

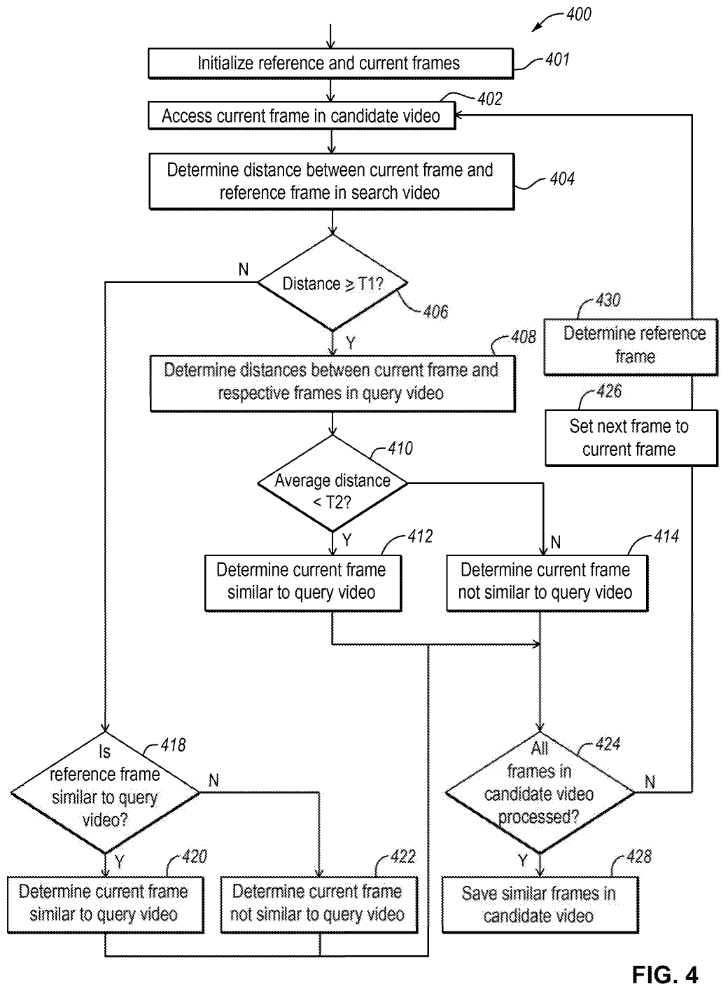

Optionally, the system 100 may further include compression systems 102, 110, configured to respectively reduce the sizes of the plurality of image frames in the query video and the candidate video to a proper size so that the plurality of image frames are suitable for uploading to a CNN model for implementing the feature extractor. In some examples, the CNN model may be executed in a physical A1 chip having hardware constraints. For example, the A1 chip may include a buffer for holding input images up to 224×224 pixels for each channel. In such case, the compression systems 102, 110 may reduce each of the image frames to a size at or smaller than 224×224 pixels. In a non-limiting example, the compression systems 102, 110 may down sample each image frame to the size constrained by the AI chip. Additionally, and/or alternatively, the compression systems 102. 110 may crop each of the plurality of image frames in a video to generate multiple instances of cropped images. For example, for an image frame having a size of 640×480, the instances of cropped images may include one or more sub-images, each of the sub-images being smaller than the original image and cropped from a region of the original image. In a non-limiting example, the system may crop the input image in a defined pattern to obtain multiple overlapping sub-images which cover the entire original image. In other words, each of the cropped images may contain image contents attributable to a feature descriptor based on each cropped image. Accordingly, for an image frame, the feature extractor 104, 112 may access multiple instances of cropped images and produce a feature descriptor based on the multiple instances of cropped images. The details will be further described with reference to FIGS. 2 and 3.

With further reference to FIG. 1, optionally, the system 100 may include a key frame extractor (e.g., 105) to further compress the query video by extracting key frames so that only feature descriptors for key frames of the query video are fed to the comparator 106. This results in a reduction of computation time for the comparator because only the feature descriptors of the key frames, rather than those of all of the image frames in the entire query video are compared. Similarly, the system 100 may also include a key frame extractor (e.g., 113) to further compress the candidate video by extracting key frames so that only feature descriptors for the key frames of the candidate video are fed to the comparator 106.

FIG. 2 illustrates an example feature extractor that may be embedded in an AI chip in accordance with various examples described herein. In some examples, the feature extractor, such as the feature extractor 104, 112 (in FIG. 1) may be implemented in an embedded cellular neural network in an AI chip 202. For example, the AI chip 202 may include a CNN 206 configured to generate feature maps for each of the plurality of image frames. The AI chip 202 may also include an invariance pooling layer 208 configured to generate the corresponding feature descriptor based on the feature maps. In some examples, the AI chip 202 may further include an image rotation unit 204 configured to produce multiple images rotated from the image frame at corresponding angles. This allows the CNN to be able to extract deep features off of the image frame.

In some examples, the invariant pooling layer 208 may be configured to determine a feature descriptor based on the feature maps obtained from the CNN. The pooling layer 208 may include a square-root pooling, an average pooling, a max pooling or a combination thereof. The CNN may also be configured to perform a region of interest (ROI) sampling on the feature maps to generate multiple updated feature maps. The various pooling layers may be configured to generate a feature descriptor for various rotated images.

FIG. 3 illustrates an example feature extractor that may be implemented in an AI chip in accordance with various examples described herein. In some examples, the cellular neural network in the AI chip may be a deep neural network (e.g., VGG-16), of which the feature descriptors may be deep feature descriptors. The feature extractor 300 may be configured to generate a feature descriptor for an input image. In generating the feature descriptor, the feature extractor may be configured to generate multiple rotated images 302 (e.g., 302(1), 302(2), 302(3), 302(4)), each being rotated from the input image at a different angle, e.g., 0, 90, 180 and 270 or other angles. Each rotated image may be fed to the CNN 304 to generate multiple feature maps 306, where each feature map represents a rotated image. The feature extractor may concatenate (stack) the feature maps front different image rotations. An invariance pooling 314 may be performed on the stacked feature maps to generate a feature descriptor, as will be further described.

Additionally, each of the feature maps from various image rotations may be nested to include multiple cropped images (regions) from the input image. The cropped images may be fed to the CNN to generate multiple feature maps, each of the feature maps representing a cropped region. The feature extractor may further concatenate (stack) the features maps from multiple cropped images nested in each set of feature maps from air image rotation. In other words, each feature map from a rotated image may include a set of feature maps comprising multiple feature maps that are concatenated (stacked together), where each feature map in the set results from a respective cropped image from a respective rotated image. As the cropped images from an input image (or rotated input image) may have different sizes, the feature maps within each set of feature maps may also have different sizes.

Additionally, and/or alternatively, a region of interest (ROl) sampling may be performed on top of each set (stack) of feature maps. Various ROl methods may be used to select one or more regions of interest from each of the feature maps. Thus, a feature map in the set of feature maps for an image rotation may be further nested to include multiple sub-feature maps, each representing a ROl within that feature map. For example, an image of a size of640x480 may result in a feature map of a size of 20×15. In a non-limiting example, the feature extractor 300 may generate two ROl samplings, each having a size of 15×15, where the two ROl samplings may be overlapping, covering the entire feature map. In another non-limiting example, the feature extractor 300 may generate six ROl samplings, each having a size of 10×10, where the six ROl samplings may be overlapping to cover the entire feature map. All of die feature maps for all image rotations and the nested sub-feature maps for ROls within each feature map may be concatenated (stacked together) tor performing the invariance pooling.

In some examples, the invariance pooling 314 may be a nested invariance pooling and may include one or more pooling operations. For example, the invariance pooling 314 may include a square-root pooling 316 performed on the ROIs of all concatenated feature/sub-feature maps to generate a plurality of values 308, each representing the square-root values of the pixels in the respective ROl. Further, the invariance pooling 314 may include an average pooling 318 to generate a feature vector 310 for each set of feature maps (corresponding to each image rotation, e.g., at 0, 90, 180 and 270 degrees, respectively), each feature vector corresponding to an image rotation and based on an average of the square-root values from multiple sub-feature maps. Further, the invariance pooling 314 may include a Max pooling 320 to generate a single feature descriptor 312 based on the maximum values of the feature vectors 310 obtained from the average pooling. As shown, for each of a plurality of image frames of a video segment, the feature extractor may generate a corresponding feature descriptor, such as 312. In a non-limiting example, the feature descriptor may include a one-dimensional (1D) vector containing multiple values. The number of values in the 1D descriptor vector may correspond to the number of output channels in the CNN.

FIG. 4 illustrates a flow diagram of an example process of determining similar image frames in a candidate video that are similar to the query video in accordance with various examples described herein A process 400 for determining similar image frames in a video segment may be implemented in a comparator, such as 106 in FIG. 1. In some examples, the process 400 may process the multiple image frames in the candidate video sequentially and determine a similarity between the query video and each image frame in the candidate video by comparing the feature descriptors of the query video and the feature descriptor of each image frame in the candidate video. Thus the determining of similarity is based on the feature descriptor (vector) instead of image pixels. In determining the similarity between the query video and each image frame in the candidate video, the process 400 may compare the feature descriptor of each image frame in the candidate video to the feature descriptor(s) of all of the image frames in the query video. Such comparison may result in multiple values, each representing a difference between a respective image frame in the query video and the image frame in the candidate video in the feature descriptor domain. The process 400 may determine the similarity between the query video and the image frame in the candidate video by combining such multiple values. For example, an averaging operation on such multiple values may be used, la other scenarios, the process 400 may determine the similarity based on other operations over the multiple values, such as maximum value, median value, or other operations.

In some examples, the process 400 may not need to compare every single image frame in the candidate video with the query video. Instead, the process 100 may set a reference frame in the candidate video and determine a similarity between the reference frame and the query video in the manner as described above. The process 400 may subsequently compare each succeeding image frame in the candidate video with the reference frame. If the succeeding image frame is similar to the reference frame, the process 400 may determine the similarity between the succeeding image frame and the query video based on the similarity between the reference frame and the query video, instead of computing the similarity between the succeeding image frame and the query video as described above. If the succeeding image frame and the reference frame are not similar, the process 400 may reset the succeeding image frame to the reference frame and compute the similarity between the reference frame and the query video in the above described manner.

Now with further reference to FIG. 4. the derails of determining similar image frames from a candidate video are described. The process 400 may initialize reference and current frames at 401. In some example, the process 400 may initialize the reference frame by selecting the first image frame in the candidate video as the reference frame. In initializing the reference frame, the process 401 may further calculate the similarity between the reference frame and the query video. In a non-limiting example, determining the similarity between the reference frame and the query video may include calculating multiple distance values, each representing a difference between the reference frame and a respective image frame in the query video, and combine the multiple distance values. For example, the multiple distance values may be averaged to determine a similarity value between the reference frame and the query video. Variously, the similarity value may be determined based on selecting a maximum value, a median of the multiple values, or other combining methods. In some examples, the similarity value may be a non-binary value converted from the distances between the reference frame and the respective image frames in the query video. The similarity value may be determined in that the higher the similarity value the likely the reference frame is close to the query video. For example, the similarity value may be determined to be based on an inverse of the distances between the reference frame and the respective image frames in the query video, in some examples, the similarity value may include a binary value, e.g., a value of one or zero, to respectively indicate whether or not the reference frame is similar to the query video. For example, the system may determine that the reference frame is similar to the query video if the average of the distances between the reference frame and respective image frames in the query video is below a threshold; otherwise, the system may determine that the reference frame is not similar to the query video.

In determining the distance between the reference frame and a respective image frame in the query video, in some example, the process may determine a distance value between the feature descriptor of the reference frame in the candidate video and the feature descriptor of the respective image frame in die query video, both of the feature descriptors are provided from the feature extractors 112 and 104, respectively. In anon-limiting example, the feature descriptor may be a ID vector. For example, if the output of the CNN implementing the feature extractor (e.g., 202 in FIG. 2) has 512 channels, the feature descriptor may be a ID vector having 512 values. In determining the distance value between feature descriptors, the process 406 may use a cosine distance.

In a non-limiting example, the distance between a first feature descriptor u and a second feature descriptor v may be expressed as:

$$1 - \frac{u \cdot v}{{‖ u ‖}_{2} {‖ v ‖}_{2}}$$

where u⋅v is the dot product of u and v and ∥u∥₂ and ∥v∥ₐ are Euclidean norms. In an example, if u and v have the same direction, then the cosine distance may have a minimal value, such as zero. If u and v are perpendicular to each other, then the cosine distance may have a maximum value, e.g., a value of one. In here, the distance value between two feature descriptors corresponding to two image frames may indicate the extent of changes between the two image frames. A higher distance value may indicate a more significant difference between the two corresponding image frames (which may indicate an occurrence of an event) than a lower distance value docs.

With further reference to box 401, in initializing the current frame, the process 400 may select the current frame as the next image frame succeeding the reference frame In some examples, the current frame may skip a number of image frames (e.g., an integer n) after the reference frame. For example, the current frame may be the reference frame+n. In other words, the process 400 may skip n image frames assuming that the image frames within the neighborhood of n frames are similar and do not need to be processed. The integer n may be any suitable number. For example, n may have a value of 10, 15,16, or other values.

With further reference to FIG. 4, the process 400 may determine the distance between the current frame and the reference frame in the candidate video at 402. In a similar manner to determining the distance between the reference frame and a respective image frame of the query video described above, the distance between the current frame and the reference frame may be determined based on the cosine distance between the two feature descriptors (vectors) associated with the current frame and the reference frame. If the distance between the current frame and the reference frame does not exceed a threshold, e.g., T1, at 406, it means that die current frame is likely similar to the reference frame and the current frame can be represented by the reference frame. Then the process 400 may skip comparing the current frame with the query video, and instead, inherit the relationship between the reference frame and the query video. For example, the process 400 may determine whether the reference frame is similar to the query video at 418. If the reference frame is similar to the query video, the process 400 may determine that the current frame is also similar to the query video at 420. Conversely, if the reference frame is not similar to the query video, the process 400 may determine that the current frame is not similar to the query video either at 422.

Returning to box 406, if the distance between the current frame and the reference frame equals or exceeds the threshold T1, it means that the current frame is likely not close to the reference frame and cannot be represented by the reference frame. Then, the process 400 may compare the current frame with the query video to determine the distances between the current frame and respective image frames in the query video at 408 in a similar manner as described in determining the similarity between the reference frame and the query video in 401. In some examples, if the average of the distances between the current frame and the respective image frames in the query video is below a threshold, e.g., T2, at 410, then the process 400 may determine that the current frame is similar to the query video at 412. Otherwise, the process 400 may determine that the current frame is not similar to the query video at 414. At this point, the distance between the current frame and the query video has just been calculated instead of inherited from the distance between the reference frame and the query video. In various embodiments, the process 400 may also use other combinations of distances to determine the similarity between the current frame and the query video. For example, the process 400 may determine whether a maximum distance or a median distance is below the threshold T2 at 410 and proceed to boxes 412 or 414 depending on the determination.

With continued reference to FIG. 4, now the current frame in the candidate video has been determined to be “similar” or “not similar” to the query video. Alternatively, and/or additionally, the similarity may have a non-binary value to indicate the degree of similarity. For example, the operation at 410 may not be needed. Instead, boxes 412 and 414 may be merged into one operation, e.g., to determine the similarity value between the current frame and the query video as a non-binary value, based on the distances obtained from operation 408. hi a non-limiting example, the similarity value may be determined based on the inverse of the distances, such that the higher the similarity value the higher degree the current frame and the query video are similar. Conversely, the lower the similarity value the lower degree the current frame and the query video are similar. Additionally, the process may normalize the distances between the current frame and the respective image frames in the query video before determining the non-binary similarity value.

With further reference to FIG. 4, the process 400 may further check whether all of the image frames in the candidate video have been processed at 424. If not ail of the image frames in the candidate video have been processed, then the process may set the next image frame in the candidate video to the current frame at 426 and repeat the operations 402-424 in the same manner described above. Additionally, the process may determine the reference frame at 430. In some examples, the reference frame may be the same as the preceding iteration. In other words, the reference frame may stay the same whereas the current frame moves frame by frame. Alternatively, and/or additionally, the process may set the reference frame as a number of frames preceding the current frame. For example, a current frame is set at 426. Subsequently, the process may set the reference frame to be 10 frames (or other suitable number of frames) preceding the current frame. If all of the image frames in the candidate video have been processed, then the process may save the similar image frames in the candidate video at 428. As illustrated in FIG. 1, the similar image frames in the candidate video may be further processed in the output system 108.

Returning to FIG. 1, the output system 108 may include outputting the query output based on the similar image frames obtained from die comparator 106. In some examples, the output system may include all of the image frames in the candidate video that are similar to the query video. In some examples, the retrieval system 100 may display the similar image frames from the candidate video in the query output to the user in a slide show so that the user can quickly assess the retrieval results. In some examples, the output system 108 may determine the beginning image frame and the ending image frame of the similar image frames from the candidate video and output a continuous video segment in the candidate video between the determined beginning and ending image frames. In such case, the user will watch the portion of the candidate video that is similar to the query video. In some or other scenarios, the output system 108 may additionally remove noise in the similar image frames obtained from the comparator. For example, one or two similar image frames may be an outlier and isolated from the majority of similar image frames. In such case, the system 100 may determine to remove those outlier similar image frames before providing the query output. For example, a filtering method may be used.

With further reference to FIG. 1, before the query video and the candidate video in the video database are fed to the comparator 106, at least one or both of the query video and the candidate video may be fed to a key frame extractor (105, 113) to further compress the video to include only key frames. This results in a saving in processing time in the comparator 106.

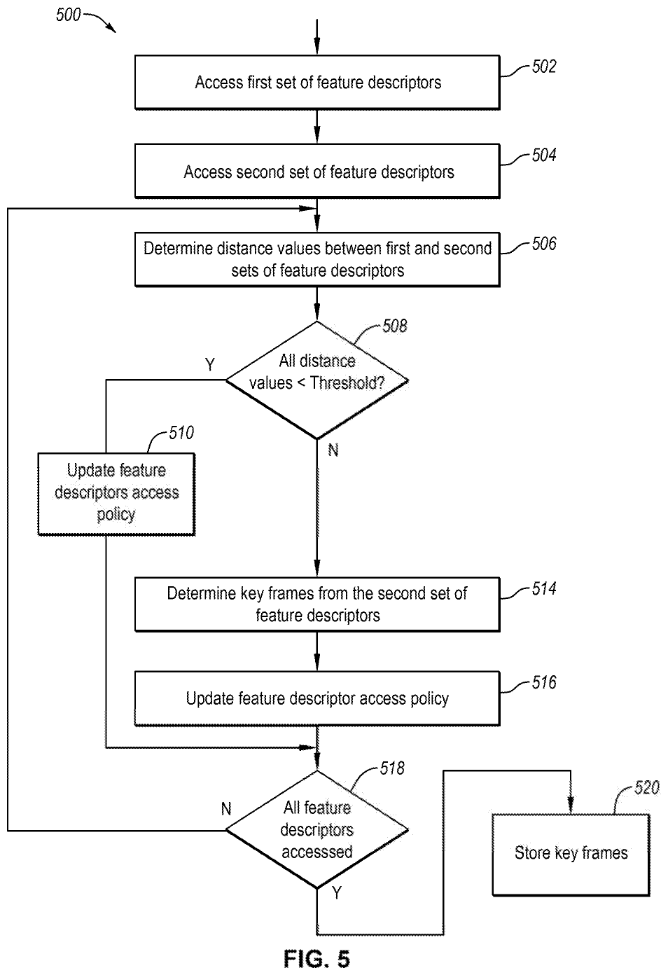

FIG. 5 illustrates a flow diagram of an example process of detecting key frames in a video segment in accordance with various examples described herein. A process 500 for detecting key frames in a video segment may be implemented in a key frame extractor, such as 105, 113 in FIG. 1. The process 500 may include accessing a first set of feature descriptors at 502 and accessing a second set of feature descriptors at 504. where the first set of feature descriptors correspond to a first subset of the plurality of image frames in the video segment and the second set of feature descriptors correspond to a second subset of image frames in the video segment. For example, the first subset of images may include image frames 1-10 and the second subset of images may include image frames 11-20. In such case, the first set of feature descriptors may include 10 feature descriptors (e.g., feature descriptor 312 in FIG. 3) each corresponding to a respective image frame in frames 1-10. The second set of feature descriptors may include 10 feature descriptors (e.g., feature descriptor 312 in FIG. 3) each corresponding to a respective image frame in frames 11-20. The process 500 may determine distance values between the first and second sets of feature descriptors at 506.

In a non-limiting example, determining the distance values between two sets of feature descriptors may include calculating a distance value between a feature descriptor pair containing a feature descriptor from the first set and a corresponding feature descriptor from the second set. In the example above, the first set of feature descriptors may include 10 vectors each corresponding to an image frame between I-10 and the second set of feature descriptors may include 10 vectors each corresponding to a respective image frame between 11-20. Then, the process of determining the distance values between the first and second sets of feature descriptors may include determining multiple distance values. For example, the process may determine a first distance value between the feature descriptor corresponding to image frame 1 (from the first set) and the feature descriptor corresponding to image frame 11 (from the second set). The process my determine the second distance value based on the descriptor corresponding to image frame 2 and the descriptor corresponding to image frame 12. The process may determine other distance values in a similar manner.

In some examples, in determining the distance value, the process 506 may use a cosine distance. For example, if a vector in the first set of feature descriptors is w, and the corresponding vector in the second set of feature descriptors is v, then the cosine distance between vectors u and

$$1 - \frac{u \cdot v}{{‖ u ‖}_{2} {‖ v ‖}_{2}}$$

where u⋅v is the dot product of u and v and |u|₂ and |v|₂ are Euclidean norms. In an example, if u and v have the same direction, then the cosine distance may have a minimal value, such as zero. If u and v are perpendicular to each other, then the cosine distance may have a maximum value, e.g., a value of one. In here, the distance value between two feature descriptors corresponding to two image frames may indicate the extent of changes between the two image frames. A higher distance value may indicate a more significant difference between the two corresponding image frames (which may indicate an occurrence of an event) than a lower distance value does. In other words, if a distance value between two feature descriptors exceeds a threshold, the system may determine that an event has occurred between the corresponding image frames. For example, the event may include a motion ill the image frame (e.g., a car passing by in a surveillance video) or a scene change (e.g., a camera installed on a vehicle capturing a scene change when driving down the road), or change of other conditions. In such case, the process may determine that the image frames where the significant changes have occurred in the corresponding feature descriptors be key frames. Conversely, a lower distance value between the feature descriptors of two image frames may indicate less significant change or no change between the two image frames, which may indicate that the two image frames contain static background of the image scenes. In such case, the process may determine that such image frames are not key frames.

With further reference to FIG. 5, the process may determine whether all distances values between the two sets of feature descriptors (corresponding to two subsets of image frames) are below a threshold at 508. If all distances values between the two sets of feature descriptors are below a threshold, the process may determine that the corresponding image frames contain background of the image scenes and are not key frames. If at least one distance value is above the threshold, then the process may determine that the corresponding image frames contain non-background information or indicate that an event has occurred. In such case, the process may determine one or more key frames from the second set of feature descriptors at 514.

In a non-limiting example, the process 514 may select the key frames from the top feature descriptors which resulted in distance values exceeding the threshold. In the example above, if the feature descriptors of image frames 14 and 15 are above the threshold, then the process 514 may determine that image frames 14 and 15 are key frames. Additionally, and/or alternatively, if the feature descriptors of multiple image frames in the second subset of image frames have exceeded the threshold, the process may select one or more top key frames whose corresponding feature descriptors have yielded highest distance values. For example, between image frames 14 and 15, the process may select frame 15, which yields a higher distance value than frame 14 docs In another non-limiting example, if image frames 11, 12, 14, 15 all yield distance values above the threshold, the process may select all of these image frames as key frames. Alternatively, the process may select two key frames whose feature descriptors yield the two highest distance values.

Now the first and second sets of feature descriptors are processed, the process 500 may move to process additional feature descriptors. In some examples, the process 500 may update a feature descriptor access policy at 510. 516 depending whether one or more key frames are detected. For example, if one or more key frames are detected at 514, the process 516 may update the first set of feature descriptors to include the current second set of feature descriptors, and update the second set of feature descriptors to include additional feature descriptors corresponding to a third subset of image frames of the plurality of image frames. In the above example, the first set of feature descriptors may be updated to include the second set of feature descriptors, such as the feature descriptors corresponding to image frames 11-20; and the second set of feature descriptors may be updated to include a new set of feature descriptors corresponding to image frames 21-30. In such case, subsequent distance values between tire first and second sets of feature descriptors may be determined based on the feature descriptors corresponding to image frames 11-20 and 21-30, respectively.

Alternatively, if no key frames are detected at 514, then the process 510 may update the second set of feature descriptors to include additional feature descriptors corresponding to a third subset of image frames of the plurality of image frames. For example, if no key frames are detected in image frames 11 -20, then the second set of feature descriptors may include feature descriptors corresponding to the new set of image frames 21-30. In some examples, the First set of feature descriptors may remain unchanged. For example, the First set of feature descriptors may remain the same and correspond to image frames 1-10. Alternatively, the First set of feature descriptors may be set to one of the feature descriptors. For example, the First set of feature descriptors may include (lie feature descriptor corresponding to image frame 10, In such case, subsequent distance values between the First and second sets of feature descriptors may be determined based on the feature descriptor corresponding to image frame 10 and feature descriptors corresponding to image frames 21-30. In other words, the image frames 11-20 are ignored.

In some examples, the process 500 may repeat blocks 506-516 until the process determines that the feature descriptors corresponding to all of the plurality of images frames in the video segment have been accessed at 518. When such determination is made, the process 500 may store the key frames at 520. Otherwise, die process 500 may continue repeating 506-516. in some variations, block 520 may be implemented when all feature descriptors have been accessed at 518. Alternatively, and/or additionally, block 520 may be implemented as key frames are detected (e.g., at 514) in one or more of the iterations. As described above with respect to FIGS. 2-3, the feature descriptor based on key frame detection may be readily implemented in an AI chip having a CNN. It is appreciated that although key frame detection based on feature descriptors is illustrated in FIG. 5, other ways of selecting key frames of a video segment may also be possible.

Returning to FIG. 1, in some examples, whether to perform key frame detection (in 105, 113) may be determined based on the number of image frames in each of the video segment, query video or the candidate video in the video database, in some examples, if the number of image frames in the query video or the candidate video is less than a first threshold value, then the system may skip the key frame detection for the video. In some examples, if the number of image frames in a video segment exceeds a second threshold value, then the system may determine to apply an aggressive image frame reduction. For example, the system may determine a key frame in at least every n image frames (or a compression ratio of n) in average. In some examples, if the number of image frames in a video segments falls between the first threshold value and the second threshold value, the system may apply another key frame detection method to guarantee that the number of key frames in the video segment is at least the first threshold value.

In a non-limiting example, the first threshold may be 100 image frames, the second threshold may be 10,000 image frames, and the value n may be 20. In this case, if the number of image frames in a video segment is less than 100, the system may process the entire video without detecting key frames. If the number of image frames in the video segment is between 100 and 10,000, the system may detect key frames in the video segment to determine at least 100 key frames. Alternatively, if the number of image frames in the video segment exceeds 10,000, the system may apply a more aggressive key frame detection so that the remaining key frames from key frame detection is about 10.000/20=500. It is appreciated that the first threshold value, the second threshold value, and/or the variable n may vary.

As described with respect to FIGS. 2-3, the feature descriptor based video retrieval may be readily implemented in a physical AI chip to extract features from an input image to produce a feature map, and/or provide feature descriptors based on the feature map. Depending on the application, the one or more of feature extractors 102, 112 may be implemented in an A1 chip. For example, in an application in which the query video is captured in real time, the feature extractor 104 may be implemented in a physical AI chip to achieve real-time video retrieval. In a non-limiting application, in a garage surveillance application, a video clip is captured for each vehicle entering the garage and stored in a video database. A video clip is also captured for each vehicle exiting the garage and compared with the previously stored video database. If the system may use the exiting video as a query video to find a match between the exiting video and the entering video clips. If the match is found, the system may determine the actual time the vehicle has parked in the garage by comparing die time stamps of the entering and exiting video clips, and determine the parking fees based on the actual parking time. In this application, as the processing of the exiting video clip requires fast processing in order avoid a delay to the driver exiting the garage, the feature extractor 104 may be implemented in an AI chip to quickly provide the feature descriptors of the exiting image, whereas the feature extractor 112 may be implemented in a CPU/GPU without an AI chip. In some examples, the feature descriptors of candidate video in the video database may be determined and pre-stored in a data repository In other scenarios, the feature extractor 112 may be implemented in an AI chip, whereas the feature extractor 104 may be implemented in a CPU/GPU. In some scenarios, both the feature extractors 104 and 112 may be implemented in an AI chip.

It will be readily understood that the components of the present solution as generally described herein and illustrated in the appended figures in FIGS. 1-5 could be arranged and made in a wide variety of different configurations. For example, the similarity bet ween an image frame and a video segment may have non-binary values to represent the extent of similarity (as described with reference to FIG. 4) between the two. A higher similarity value may indicate higher similarity and a lower value may indicate lower similarity. In such case, the output of the comparator (FIG. 1) may include all of the image frames in the candidate video with non-binary similarity values for each image frame, whereas the similarity value indicates the similarity between a respective image frame in the candidate video and the query video. Consequently, the output system 108 (FIG. 1) may be configured to select image frames from the candidate video based on the non-binary similarity values. In a non-limiting example, the output system 108 may select the image frames in the candidate video that have similarity values above a threshold. In another non-limiting example, the output system 108 may use a clustering method to determine a cluster of image frames from the candidate video that have the highest average similarity values (relative to the query video). In some variations, the non-binary similarity values of the image frames in the candidate video may form a similarity profile. The system 100 may also use a filtering method to smoothen the similarity profile to remove some noise before determining the query output. In further variations, the compression systems 102,110 in the system 100 mayor may not co-exist.

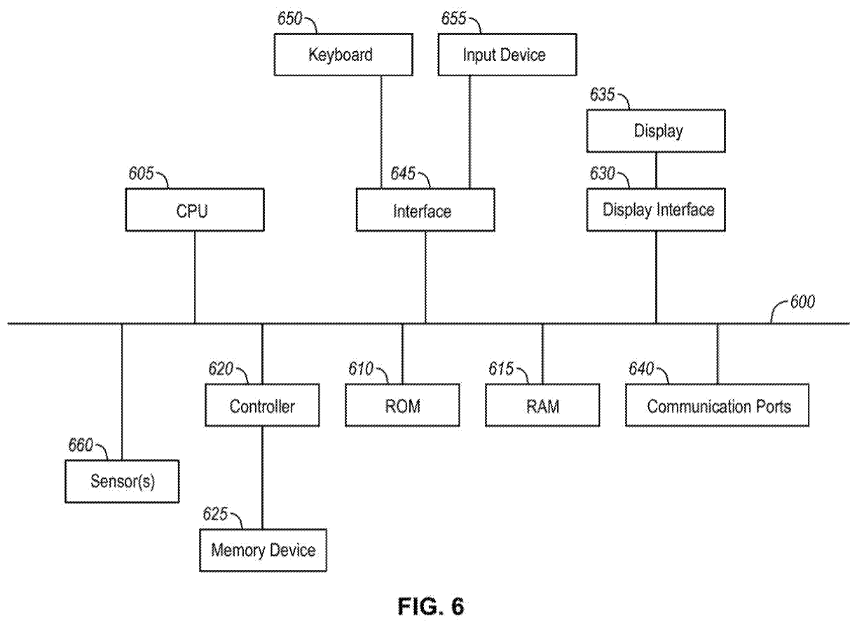

FIG. 6 illustrates various embodiments of one or more electronic devices for implementing the various methods and processes described in FIGS. 1-5. An electrical bus 600 serves as an information highway interconnecting the other illustrated components of the hardware. Processor 605 is a central processing device of the system, configured to perform calculations and logic operations required to execute programming instructions. As used in this document and in the claims, the terms “processor” and “processing device” may refer to a single processor or any number of processors in a set of processors that collectively perform a process, whether a central processing unit (CPU) or a graphics processing unit (GPU), or a combination of the two. Read only memory (ROM), random access memory (RAM), flash memory, hard drives, and other devices capable of storing electronic data constitute examples of memory devices 625. A memory device, also referred to as a computer-readable medium, may include a single device or a collection of devices across which data and/or instructions are stored.

An optional display interface 630 may permit information from the bus 600 to be displayed on a display device 635 in visual, graphic, or alphanumeric format. An audio interface and audio output (such as a speaker) also may be provided. Communication with external devices may occur using various communication ports 640 such as a transmitter and/or receiver, antenna, an RFID tag and/or short-range, or near-field communication circuitry. A communication port 640 may be attached to a communications network, such as the Internet, a local area network, or a cellular telephone data network.

The hardware may also include a user interlace sensor 645 that allows for receipt of data from input devices 650 such as a keyboard, a mouse, a joystick, a touchscreen, a remote control, a pointing device, a video input device, and/or an audio input device, such as a microphone. Digital image frames may also be received from an image capturing device 655 such as a video or camera that can either be built-in or external to the system. Other environmental sensors 660, such as a GPS system and or a temperature sensor, may be installed on system and communicatively accessible by the processor 605, either directly or via the communication ports 640. The communication ports 640 may also communicate with the AI chip to upload or retrieve data to/from the chip. For example, a processing device on the network may be configured to perform operations in the image sizing unit (FIG. I) to and upload the image frames to the AI chip for performing feature extraction via the communication port 640. Optionally, the processing device may use an SDK (software development kit) to communicate with the AI chip via the communication port 640. The processing device may also retrieve the feature descriptors at the output of the AI chip via the communication port 640. The communication port 640 may also communicate with any other interface circuit or device that is designed for communicating with an integrated circuit.

Optionally, the hardware may not need to include a memory, but instead programming instructions are run on one or more virtual machines or one or more containers on a cloud. For example, the various methods illustrated above may be implemented by a server on a cloud that includes multiple virtual machines, each virtual machine having an operating system, a virtual disk, virtual network and applications, and the programming instructions for implementing various functions in the robotic system may be stored on one or more of those virtual machines on the cloud.

Various embodiments described above may be implemented and adapted to various applications. For example, the AI chip having a cellular neural network architecture may be residing in an electronic mobile device. The electronic mobile device may use a built-in AI chip to generate the feature descriptor. In some scenarios, the mobile device may also use the feature descriptor to implement a video search application such as described with reference to FIG. 1. In other scenarios, the processing device may be a server device on a communication network or may be on the cloud. The processing device may execute an A1 chip or access the feature descriptors generated from the A1 chip and perform image retrieval based on die feature descriptors. These are only examples of applications in which various systems and processes may be implemented.

The various systems and methods disclosed in this patent document provide advantages over the prior art, whether implemented, standalone, or combined. For example, by using the feature descriptors to retrieval video, the amount of information for video retrieval are reduced from a two-dimensional array of pixels to 1D vectors. This is advantageous in that the processing associated with video retrieval is done at feature vector level instead of pixel level, allowing the process to take into consideration a richer set of image features while reducing the memory space required for search video at pixel level and computing time. Further, the comparator (e.g., 106 in FIG. 1) that implements the process in FIG. 4 may be advantageous in that it detects the key frames and similar image frames in one pass. In other words, the system compresses the video while performing the retrieval.

Further, the configuration of the feature extractor (e.g., 104,112 in FIG. 1) such as 202 (FIG. 2) may be suitable for implementation in an AI chip. This will reduce the computation time for video retrieval. Additionally, and/or alternatively, the feature extractor may also be used to select key frames off of a video before the video retrieval is performed. This further expedites the processing speed of video retrieval. Various other advantages can be evident in the present disclosure.

It will be recognized by those skilled in the art that changes, modifications, or combinations may be made to the above-described embodiments without departing from the broad inventive concepts of the invention. It should therefore be understood that the present solution is not limited to the particular embodiments described herein, but is intended to include all changes, modifications, and all combinations of various embodiments that are within the scope and spirit of the invention as defined in the claims.

What is claimed is:

1. A system comprising:
a processor;
an artificial intelligence (AI) chip; and
non-transitory computer readable medium containing programming instructions that, when executed, will cause the processor to;
access a plurality of image frames of a first video;
use die AI chip to determine first feature descriptors of the first video, each of the first feature descriptors associated with a respective image frame of the plurality of image frames of die first video;
access second feature descriptors of a second video, each of the second feature descriptors associated with a respective image frame of a plurality of image frames of the second video; and
compare the first feature descriptors and the second feature descriptors to determine a subset of image frames in the second video.

2. The system of claim 1 further comprising programming instructions configured to display a query output based on the subset of image frames in the second video, wherein the subset of image frames in the second video include image frames in the second video that are similar to the first video, and wherein the query output includes a slide show of the subset of image frames.

3. The system of claim 1 further comprising programming instructions configured to display a query output based on the subset of image frames in the second video, wherein the subset of image frames in the second video includes image frames in the second video that are similar to the first video, and wherein the query output includes a video comprising at least the subset of image frames.

4. The system of claim 1, wherein the programming instructions for comparing the first feature descriptors and the second feature descriptors to determine the subset of image frames in the second video further comprise programming instructions configured to:
for each image frame of the plurality of image frames in the second video, determine whether the image frame is similar to the first video; and
determine the subset of image frames that are similar to the first video.

5. The system of claim 4. wherein the programming instructions for determining whether the image frame in the second video is similar to the first video further comprise programming instructions configured to:
determine a distance between the image frame in the second video and a reference frame in the second video; and
upon determining that the distance between the image frame in the second video and the reference frame in the second video is below a first threshold, determine whether the image frame is similar to the first video based on whether the reference frame is similar to the first video; otherwise
determine whether the image frame is similar to the first video by comparing the image frame with the first video.

6. The system of claim 5 further comprising programming instructions configured to, upon determining whether the image frame is similar to the first video by comparing the image frame with the first video:
determine the reference frame and a next image frame in the second video; and
determine whether the next image in the second video is similar to the first video based on whether the reference frame is similar to the first video.

7. The system of claim 5, wherein the programming instructions for determining whether the image frame is similar to the first video further comprise programming instructions configured to:
determine a plurality of distance values each between the image frame and a respective image frame of the plurality of image frames of the first video; and
combine the plurality of distance values to determine whether the image frame is similar to the first video.

8. The system of claim 7, wherein the programming instructions for combining the plurality of distance values to determine whether the image frame is similar to the first video farther comprise programming instructions configured to:
perform an average operation on the plurality of distance values to determine an average distance; and
upon determining the average distance is below a second threshold, determine that the image frame is similar to the first video; otherwise
determine that the image frame is not similar to the first video.

9. The system of claim 5 further comprising programming instructions configured to: initialize the reference frame in the second video;
determine whether the reference frame is similar to the first video by:
determining a plurality of distance values each between the reference frame and a respective image frame of the plurality of image frames of the first video; and
determining an average distance of the plurality of distance values; and
upon determining the average distance is below a second threshold, determining that the reference frame is similar to the first video: otherwise
determining that the image frame is not similar to the first video.

10. The system of claim 1, wherein the programming instructions for determining one of the first feature descriptors associated with the respective image frame of the first video further comprise programming instructions configured to execute the AI chip configured to:
determine one or more feature maps of the respective image frame; and
use an invariance pooling layer to generate die feature descriptor based on the one or more feature maps.

11. The system of claim 1 further comprising an image sensor configured to capture the plurality of image frames of the first video.

12. A method comprising, at a processing device:
accessing a plurality of image frames of a first video;
using an artificial intelligence (AI) chip to determine first feature descriptors of the first video, each of the first feature descriptors associated with a respective image frame of the plurality of image frames of the first video;
accessing second feature descriptors of a second video, each of the second feature descriptors associated with a respective image frame of a plurality of image frames of the second video;
comparing the first feature descriptors and the second feature descriptors to determine a subset of image frames in the second video; and
outputting a query output based on the subset of image frames in the second video.

13. The method of claim 12, wherein outputting the query output comprises displaying a slide show of the subset of image frames, wherein the subset of image frames in the second video include image frames in the second video that are similar to the first video.

14. The method of claim 12, wherein outputting die query output comprises displaying a video comprising at least the subset of image frames, wherein the subset of image frames in the second video include image frames in the second video that are similar to the first video.

15. The method of claim 12, wherein comparing the first feature descriptors and the second feature descriptors to determine the subset of image frames in the second video comprises:
for each image frame of the plurality of image frames in the second video, determining whether the image frame is similar to the first video; and
determining the subset of image frames that are similar to the first video.

16. The method of claim 15, wherein determining whether the image frame in the second video is similar to the first video further comprises:
determining a distance between the image frame in the second video and a reference frame in the second video; and
upon determining that the distance between the image frame in the second video and the reference frame in the second video is below a first threshold, determining whether the image frame is similar to the first video based on whether the reference frame is similar to the first video; otherwise
determining whether the image frame is similar to the first video by comparing the image frame with the first video.

17. The method of claim 16 further comprising, upon determining whether the image frame is similar to the first video by comparing the image frame with the first video:
determining the reference frame and a next image frame in the second video, and
determining whether the next image in the second video is similar to the first video based on whether the reference frame is similar to the first video.

18. The method of claim 16, wherein determining whether the image frame is similar to the first video comprises:
determining a plurality of distance values each between the image frame and a respective image frame of the plurality of image frames of the first video; and
combining the plurality of distance values to determine whether the image frame is similar to the first video.

19. The method of claim 18, wherein combining the plurality of distance values to determine whether the image frame is similar to the first video comprises.
performing an average operation on the plurality of distance values to determine an average distance; and
upon determining the average distance is below a second threshold, determining that the image frame is similar to the first video: otherwise
determining that the image frame is not similar to the first video.

20. The method of claim 16 further comprising:
initialize the reference frame in the second video;
determining whether the reference frame is similar to the first video by;
determining a plurality of distance values each between the reference frame and a respective image frame of the plurality of image frames of the first video; and
determining an average distance of the plurality of distance values; and
upon determining the average distance is below a second threshold, determining that the reference frame is similar to the first video; otherwise
determining that the image frame is not similar to the first video.
